(19) United States
(12) Patent Application Publication
(10) Pub. No.: US 2007/0178362 A1
(43) Pub. Date: Aug. 2, 2007

(54) Fuel cell stack

(75) Inventor: Tomio Miyazaki, Suginami-ku (JP)

Correspondence Address: LAHIVE & COCKFIELD, LLP, ONE POST OFFICE SQUARE, BOSTON, MA, 02109-2127, US

(73) Assignee: Honda Motor Co., Ltd., Tokyo (JP)

(21) Appl. No.: 11/700,305

(22) Filed: Jan. 31, 2007

(30) Foreign Application Priority Data
Jan. 31, 2006 (JP) 2006-023084

(51) Int. Cl. H01M 8/24

(52) U.S. Cl. 429/38; 429/34

(57) ABSTRACT

A fuel cell stack is formed by stacking a plurality of fuel cells each of which is formed by stacking electrolyte electrode assemblies and a separator alternately. A channel member is joined to the separator to form a fuel gas supply channel between the separator and the channel member. The fuel gas supply channel is connected to a fuel gas channel through a fuel gas inlet, and connected to an internal chamber. The internal chamber is connected to a fuel gas storage chamber through a fuel gas intake port to form a fuel gas supply unit. When a plurality of the separators are stacked together, the fuel gas supply unit forms the chamber extending in the stacking direction.

### BACKGROUND OF THE INVENTION

1. Field of the Invention

The present invention relates to a fuel cell stack formed by stacking a plurality of fuel cells, each of which is formed by stacking an electrolyte electrode assembly and a separator. The electrolyte electrode assembly includes an anode, a cathode, and an electrolyte interposed between the anode and the cathode.

2. Description of the Related Art

Typically, a solid oxide fuel cell (SOFC) employs an electrolyte of ion-conductive solid oxide such as stabilized zirconia. The electrolyte is interposed between an anode and a cathode to form an electrolyte electrode assembly. The electrolyte electrode assembly is interposed between separators (bipolar plates). In practical use, the predetermined number of the electrolyte electrode assemblies and the separators are stacked together to form a fuel cell stack.

In the fuel cell, in order to supply a fuel gas such as a hydrogen-containing gas and an oxygen-containing gas such as the air to the anode and the cathode, respectively, a fuel gas channel and an oxygen-containing gas channel are formed along separator surfaces. The fuel cell stack may have internal manifold structure in which a fuel gas supply passage and an oxygen-containing gas supply passage extend in the stacking direction for distributing the fuel gas and the oxygen-containing gas to the fuel gas channels and the oxygen-containing gas channels, respectively.

For example, Japanese Laid-Open Patent Publication No. 10-172594 discloses a solid oxide fuel cell as shown in FIG. 21. The solid oxide fuel cell has gas intake holes 1a and gas discharge holes 1b extending through four corners of a separator 1. A plurality of gas grooves 1c and ridges 1d are arranged alternately in the separator 1 for distributing a fuel gas or an oxygen-containing gas.

The gas intake hole 1a and the gas grooves 1c are connected through a triangular recess 1e, and the gas discharge hole 1b and the gas grooves 1c are connected through a triangular recess 1f. Throttle pieces 2 and/or blocks 3 for regulating the flow rate of the gas are provided in a gas inlet area in the triangular recess 1e near the gas intake hole 1a.

In the structure, the pressure loss at the gas inlet area is increased, and it is not necessary to consider the pressure loss in the gas intake hole 1a. According to the disclosure, the flow rate of the gas supplied to the separator 1 on the downstream side in the gas flow is not reduced.

In the conventional technique, the throttle pieces 2 and/or the blocks 3 are provided in each gas inlet area of each separator 1. In the structure, though the flow rate of the gas to the gas grooves 1c becomes uniform in each separator 1, the gas is not divided evenly to the respective separators 1 stacked in the stacking direction. Thus, it is difficult to achieve the uniform power generation in the stacking direction.

### SUMMARY OF THE INVENTION

The present invention has been made to solve the problem, and an object of the present invention is to provide a fuel cell stack having simple and economical structure in which it is possible to supply reactant gases uniformly to electrode surfaces of electrolyte electrode assemblies stacked in a stacking direction, and achieve uniform power generation reaction in the stacking direction.

The present invention relates to a fuel cell stack formed by stacking a plurality of fuel cells, each of which is formed by stacking an electrolyte electrode assembly and a separator. The electrolyte electrode assembly includes an anode, a cathode, and an electrolyte interposed between the anode and the cathode.

The fuel cell comprises a fuel gas channel provided on one surface of the separator for supplying a fuel gas along a surface of the anode, an oxygen-containing gas channel provided on the other surface of the separator for supplying an oxygen-containing gas along a surface of the cathode, a fuel gas supply passage extending through the separator in a stacking direction of the separator for allowing the fuel gas to flow in the stacking direction, a fuel gas supply unit provided in the separator for dividing the flow of the fuel gas, and supplying the fuel gas from the fuel gas supply passage to the fuel gas channel of the separators. The fuel gas supply unit forms a chamber extending through the separators in the stacking direction when the plurality of fuel cells are stacked together.

Preferably, the fuel gas supply unit comprises a fuel gas storage chamber connected to the fuel gas supply passage, a fuel gas intake port connected to the fuel gas storage chamber for taking the fuel gas from the fuel gas storage chamber, and a fuel gas supply channel for supplying the fuel gas taken from the fuel gas intake port to the fuel gas channel, and the separator has a fuel gas inlet connecting the fuel gas supply channel and the fuel gas channel for supplying the fuel gas to the anode, and the pressure loss at the fuel gas intake port is larger than the pressure loss at the fuel gas supply passage. By reducing the cross sectional area of the fluid channel at the fuel gas intake port, the pressure loss occurs. Thus, it is possible to supply the fuel gas, at a uniform flow rate, to the fuel gas supply passage at the respective separators stacked in the stacking direction.

Further, preferably, the total opening area of the fuel gas intake port is smaller than the total opening area of the fuel gas supply passage.

Further, preferably, the pressure loss at the fuel gas intake port is larger than the pressure loss at the fuel gas inlet. In this manner, it is possible to regulate the fuel gas to have the same pressure in the fuel gas storage chamber, and the fuel gas can be distributed equally to the separators arranged in the stacking direction. Further, it is possible to increase the opening area of the fuel gas intake port. Fabrication becomes easy, and reduction in the fabrication cost is achieved easily.

Further, preferably, the flow rate of the fuel gas at the fuel gas intake port is larger than the flow rate of the fuel gas at the fuel gas inlet. As in the case as described above, in this manner, it is possible to equally distribute the fuel gas to the separators arranged in the stacking direction.

Further, preferably, the fuel gas supply unit is branched into a plurality of the fuel gas supply channels, and a plurality of the electrolyte electrode assemblies are provided along a surface of the separator for each of the fuel gas supply channels. In the structure, the fuel gas is regulated to flow into the fuel gas supply channels at the same pressure, the fuel gas is supplied equally to the electrolyte electrode assemblies, and the uniform power generation reaction is achieved. Further, even if one or more of the electrolyte electrode assemblies are damaged, it is possible to continue the uniform power generation reaction using the other electrolyte electrode assemblies.

Further, preferably, the fuel gas supply unit is provided at the center of the separator, and a plurality of the electrolyte electrode assemblies are arranged along one virtual circle around the fuel gas supply unit. In the structure, it is possible to maintain the uniform temperature distribution in the electrolyte electrode assemblies.

Further, preferably, the fuel gas supply unit has an internal chamber connected to the fuel gas storage chamber through the fuel gas intake port, and the internal chamber is integrally connected to a plurality of the fuel gas supply channels. In the structure, the fuel gas is regulated to have the same pressure in the internal chamber, and supplied equally to the respective electrolyte electrode assemblies through the fuel gas supply channels at the same flow rate.

Further, preferably, the separator comprises a single plate, the fuel gas channel is provided between one surface of the plate and the anode, the oxygen-containing gas channel is provided between the other surface of the plate and the cathode, and a fuel gas channel member forming the fuel gas supply channel is provided on the one surface or on the other surface of the plate.

Further, preferably, the separator comprises first to third plates which are stacked together, the fuel gas channel is formed between the first plate and the anode, the oxygen-containing gas channel is formed between the third plate and the cathode, the fuel gas supply channel is formed between the first plate and the second plate, and the oxygen-containing gas supply channel is formed between the third plate and the second plate.

Further, according to another aspect of the present invention, the fuel cell comprises a fuel gas channel, an oxygen-containing gas channel, an oxygen-containing gas supply passage for allowing the oxygen-containing gas to flow through the separators in the stacking direction, and an oxygen-containing gas supply unit for dividing the flow of the oxygen-containing gas, and supplying the oxygen-containing gas to the oxygen-containing gas channel. The oxygen-containing gas supply unit forms a chamber extending in the stacking direction when the fuel cells are stacked together.

According to the present invention, the fuel gas supply unit is provided in each of the separators for supplying the fuel gas from the fuel gas supply passage to the fuel gas channel. When the fuel cells are stacked together, the fuel gas supply unit forms a single chamber extending in the stacking direction. Therefore, in the chamber, the pressure of the fuel gas becomes constant, and the fuel gas is stored in the respective fuel gas supply units of the stacked fuel cells at the same pressure. Thus, it is possible to supply the fuel gas from the fuel gas supply units to the fuel gas channels at the same flow rate, and the uniform power generation reaction in the stacking direction is achieved. With the simple and economical structure, it is possible to uniformly and suitably supply the fuel gas to the electrode surfaces of the stacked electrolyte electrode assemblies, and the power generation performance is suitably improved entirely in the stacking direction.

The above and other objects, features and advantages of the present invention will become more apparent from the following description when taken in conjunction with the accompanying drawings in which preferred embodiments of the present invention are shown by way of illustrative example.

### BRIEF DESCRIPTION OF THE DRAWINGS

FIG. 1 is a perspective view schematically showing a fuel cell stack formed by stacking fuel cells according to a first embodiment of the present invention;

FIG. 2 is an exploded perspective view showing the fuel cell;

FIG. 3 is a partial exploded perspective view showing gas flows in the fuel cell;

FIG. 4 is a view showing a separator;

FIG. 5 is a cross sectional view schematically showing operation of the fuel cell;

FIG. 6 is a perspective view showing a main portion of the fuel cell;

FIG. 7 is an exploded perspective view showing a fuel cell used in a fuel cell stack according to a second embodiment of the present invention;

FIG. 8 is a front view showing a separator of the fuel cell;

FIG. 9 is a cross sectional view schematically showing operation of the fuel cell;

FIG. 10 is an exploded perspective view showing a fuel cell used in a fuel cell stack according to a third embodiment of the present invention;

FIG. 11 is a cross sectional view schematically showing operation of the fuel cell;

FIG. 12 is an exploded perspective view showing a fuel cell used in a fuel cell stack according to a fourth embodiment of the present invention;

FIG. 13 is a cross sectional view schematically showing operation of the fuel cell;

FIG. 14 is perspective view schematically showing a fuel cell stack formed by stacking fuel cells according to a fifth embodiment of the present invention;

FIG. 15 is an exploded perspective view showing the fuel cell;

FIG. 16 is a partial exploded perspective view showing gas flows in the fuel cell;

FIG. 17 is a cross sectional view schematically showing operation of the fuel cell;

FIG. 18 is a perspective view schematically showing a fuel cell stack formed by stacking fuel cells according to a sixth embodiment of the present invention;

FIG. 19 is an exploded perspective view showing the fuel cell;

FIG. 20 is a cross sectional view showing operation of the fuel cell; and

FIG. 21 is a view showing a conventional fuel cell.

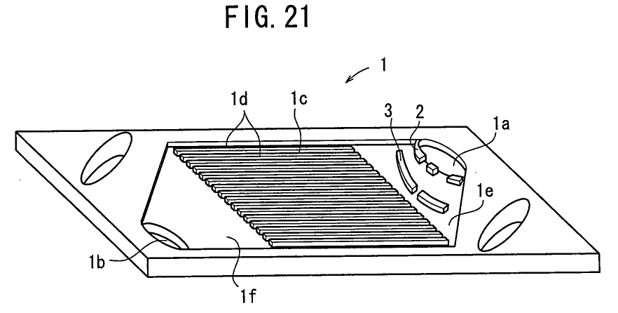

### DESCRIPTION OF THE PREFERRED EMBODIMENTS

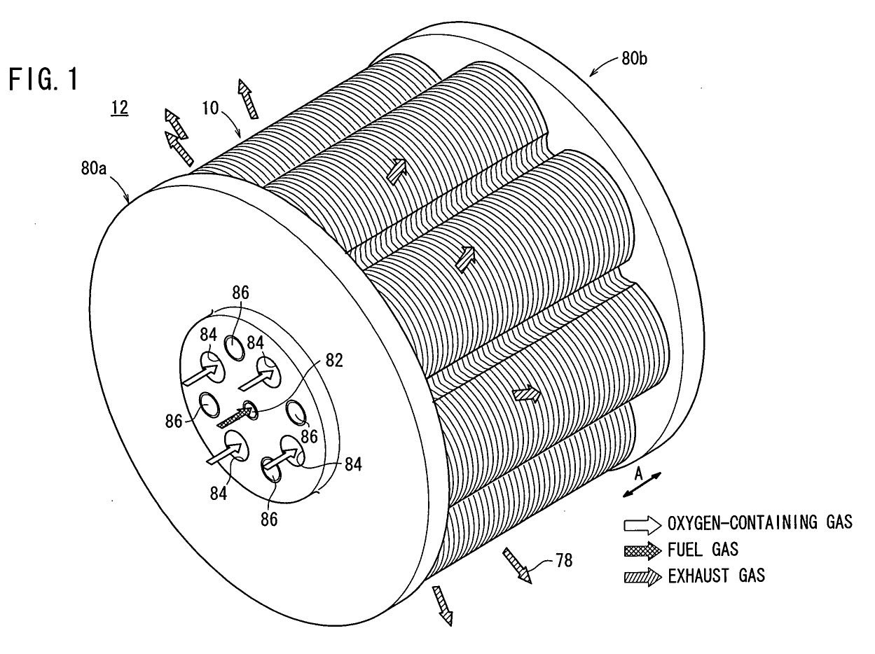

FIG. 1 is a perspective view schematically showing a fuel cell stack 12 formed by stacking fuel cells 10 in a direction indicated by an arrow A according to a first embodiment according to the present invention.

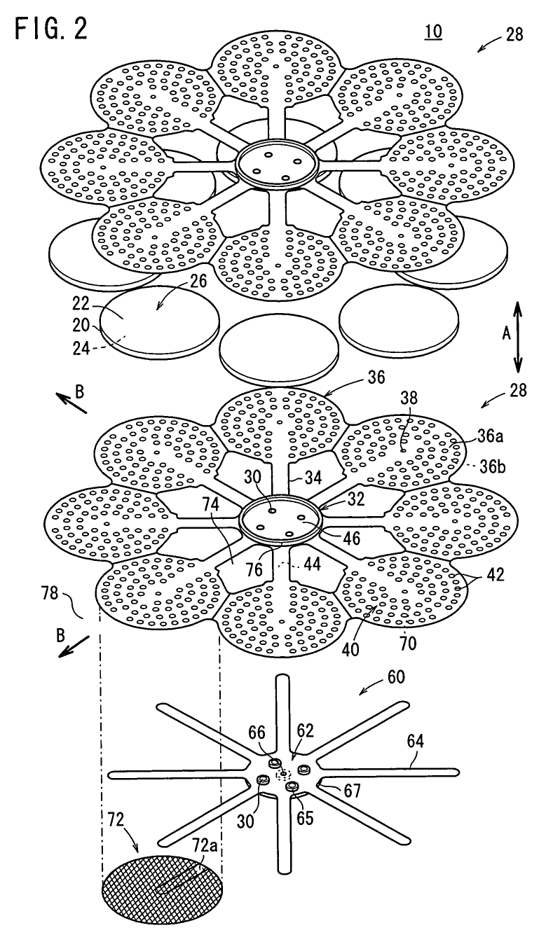

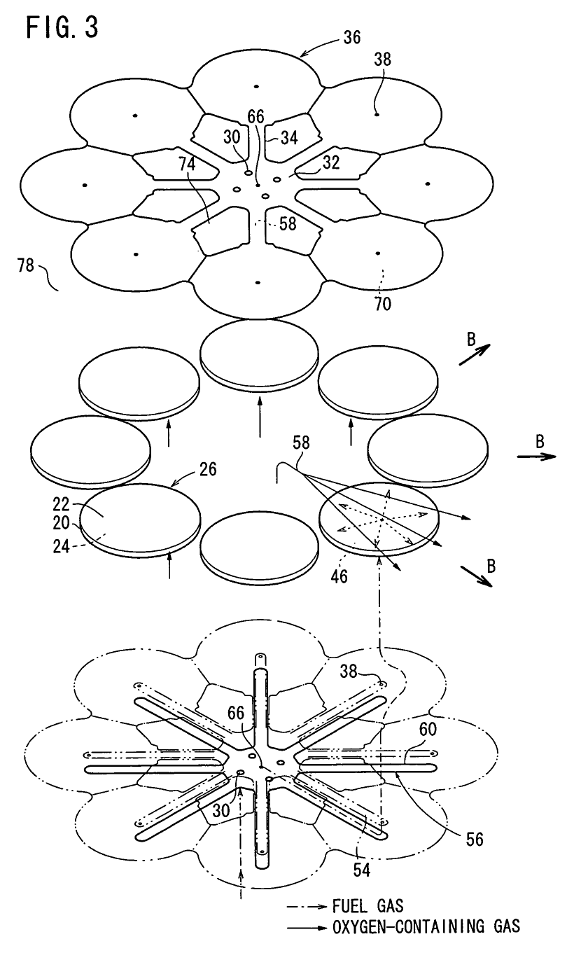

The fuel cell stack 12 is used in various applications, including stationary and mobile applications. For example, the fuel cell stack 12 is mounted on a vehicle. The fuel cell 10 is a solid oxide fuel cell (SOFC). As shown in FIGS. 2 and 3, the fuel cell 10 includes electrolyte electrode assemblies 26. Each of the electrolyte electrode assemblies 26 includes a cathode 22, an anode 24, and an electrolyte (electrolyte plate) 20 interposed between the cathode 22 and the anode 24. For example, the electrolyte 20 is made of ion-conductive solid oxide such as stabilized zirconia. A barrier layer (not shown) is provided at least at the outer circumferential edge of the electrolyte electrode assembly 26 for preventing the entry/emission of the oxygen-containing gas and the fuel gas.

A plurality of, e.g., eight electrolyte electrode assemblies 26 are sandwiched between a pair of separators 28 to form the fuel cell 10. The eight electrolyte electrode assemblies 26 are aligned along a virtual circle concentric with the center of the separators 28. In FIG. 2, for example, each of the separators 28 comprises a single metal plate of, e.g., stainless alloy or a carbon plate. The separator 28 has a first small diameter end portion 32 forming, e.g., four fuel gas supply passages 30 along a virtual circle concentric with the center of the separators 28. The first small diameter end portion 32 is integral with circular disks 36 through a plurality of first bridges 34. The first bridges 34 extend radially outwardly from the first small diameter end portion 32 at equal angles (intervals).

The circular disk 36 and the electrolyte electrode assembly 26 have substantially the same size. A fuel gas inlet 38 for supplying the fuel gas is formed at the center of the circular disk 36, or at an upstream position deviated from the center of the circular disk 36 in the flow direction of the oxygen-containing gas.

Each of the circular disks 36 has a fuel gas channel 40 on its surface 36a which contacts the anode 24 for supplying a fuel gas along a surface of the anode 24. The fuel gas channel 40 is formed by a plurality of projections 42 on a surface 36a of each circular disk 36.

The projections 42 are solid portions formed by, e.g., etching on the surface 36a. Various shapes such as a rectangular shape, a circular shape, or a triangular shape can be adopted as the cross sectional shape of the projections 42. The positions or the density of the projections 42 can be changed arbitrarily depending on the flow state of the fuel gas or the like. Other projections as described later have the same structure as the structure of the projections 42.

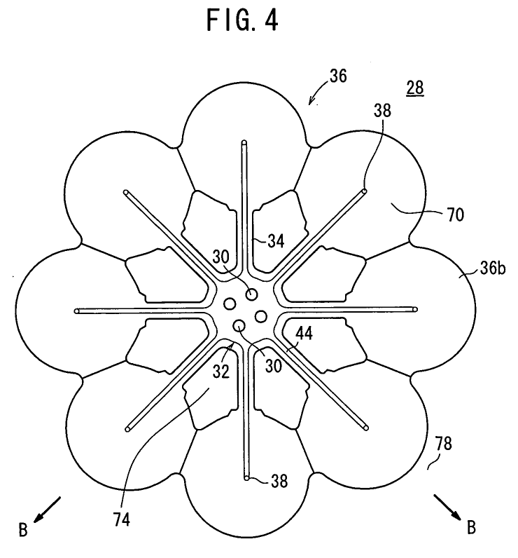

As shown in FIG. 4, each of the circular disks 36 has a substantially planar surface 36b which contacts the cathode 22. A fuel gas supply channel 44 extends from the first small diameter end portion 32 to the first bridge 34. The fuel gas supply channel 44 connects the fuel gas supply passage 30 to the fuel gas inlet 38. For example, the fuel gas supply channel 44 is formed by etching.

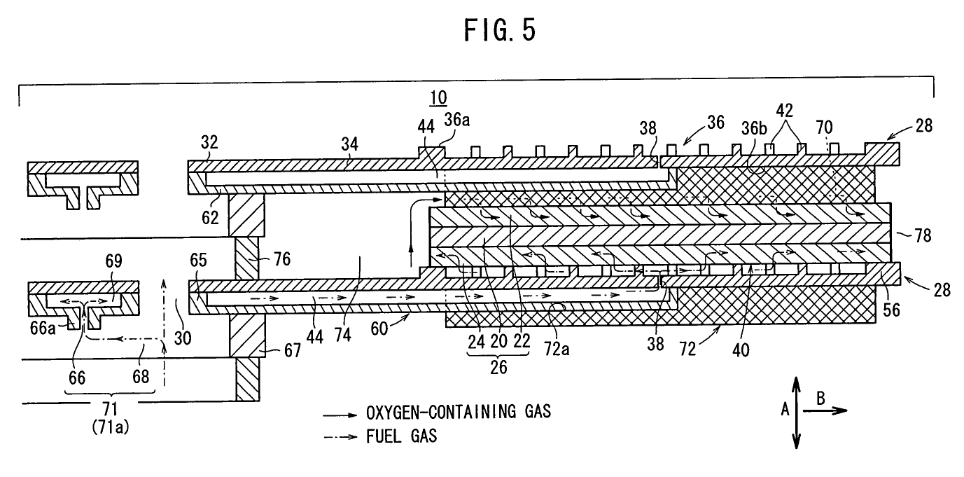

As shown in FIG. 2, a channel member (fuel gas channel member) 60 is fixed to the separator 28 by, e.g., brazing or laser welding on a surface facing the cathode 22. The channel member 60 has a substantially planar shape, and includes a second small diameter end portion 62 forming four fuel gas supply passage 30 at an central region along a virtual circle. Eight second bridges 64 extend radially from the second small diameter end portion 62. Each of the second bridges 64 is fixed to the separator 28, from the first bridge 34 to the surface 36b of the circular disk 36, while covering the fuel gas inlet 38 (see FIG. 5).

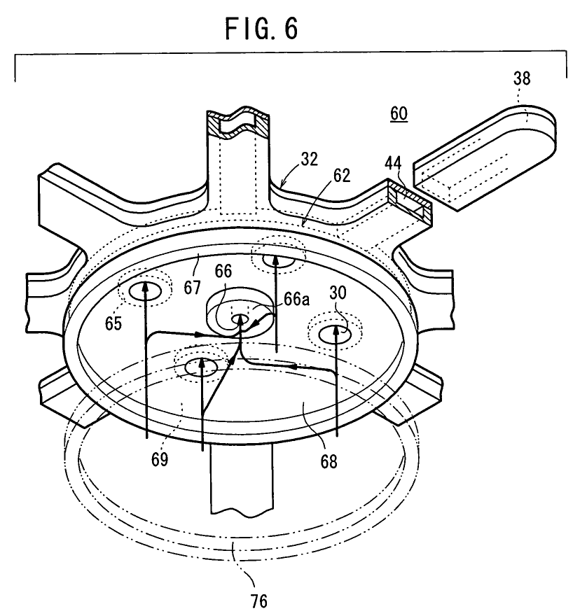

As shown in FIGS. 5 and 6, the second small diameter end portion 62 has ring shaped protrusions 65 around the respective fuel gas supply passages 30. The ring shaped protrusions 65 protrude from a surface of the second small diameter end portion 62 to which the separator 28 is fixed. A boss 66a is provided at the center of the second small diameter end portion 62 on the side opposite to the surface to which the separator 28 is fixed. A fuel gas intake port 66 is formed in the boss 66a. A ring 67 is provided separately from, or integrally with the second small diameter end portion 62 on the surface where the boss 66a is provided. A fuel gas storage chamber 68 is formed inside the ring 67. The fuel gas storage chamber 68 is connected to the fuel gas supply passages 30 and the fuel gas intake port 66.

When the second small diameter end portion 62 is joined to the first small diameter end portion 32, an internal chamber 69 is formed between the second small diameter end portion 62 and the first small diameter end portion 32. The internal chamber 69 is connected to the fuel gas storage chamber 68 through the fuel gas intake port 66, and integrally connected to a plurality of fuel gas supply channels 44.

The fuel gas storage chamber 68, the fuel gas intake port 66, and the internal chamber 69 form a fuel gas supply unit 71. When the separators 28 are stacked in the direction indicated by the arrow A, the fuel gas supply unit 71 forms a chamber 71a extending through the fuel cell stack in the stacking direction. When the protrusions 65 are joined to the first small diameter portion 32 around the fuel gas supply passages 30, the internal chamber 69 is sealed from the fuel gas supply passages 30. The opening area of the fuel gas intake port 66 is smaller than the total opening area of the four fuel gas supply passages 30, and the pressure loss in the fuel gas intake port 66 is larger than the pressure loss in the fuel gas inlet 38.

The fuel gas is supplied from the fuel gas storage chamber 68 and the fuel gas intake port 66 to a plurality of, e.g., eight electrolyte electrode assemblies 26. Therefore, the flow rates of the fuel gas in the fuel gas storage chamber 68 and at the fuel gas intake port 66 are at least eight times as large as the flow rate of the fuel gas at the opening area of the fuel gas inlet 38. Thus, even if the opening area of the fuel gas intake port 66 is larger than the fuel gas inlet 38, due to the flow rate difference of the fuel gas, the pressure loss at the fuel gas intake port 66 becomes significantly large.

On the surface 36b of the circular disk 36, a deformable elastic channel member such as an electrically conductive mesh member 72 is provided. The elastically conductive mesh member 72 forms an oxygen-containing gas channel 70 for supplying an oxygen-containing gas along a surface of the cathode 22, and the electrically conductive mesh member 72 tightly contacts the cathode 22.

For example, the mesh member 72 is made of stainless steel wire rod (SUS material), and has a circular disk shape. The thickness of the mesh member 72 is determined such that the mesh member 72 is desirably deformed elastically when a load in the stacking direction indicated by the arrow A is applied to the mesh member 72. The mesh member 72 directly contacts the surface 36b of the circular disk 36, and has a cutout 72a as the space for providing the channel member 60 (see FIGS. 2 and 5).

As shown in FIG. 5, the area where the mesh member 72 is provided is smaller than the power generation area of the anode 24. The oxygen-containing gas channel 70 formed in the mesh member 72 is connected to the oxygen-containing gas supply passage 74. The oxygen-containing gas is supplied in the direction indicated by the arrow B through the space between the inner circumferential edge of the electrolyte electrode assembly 26 and the inner circumferential edge of the circular disk 36. The oxygen-containing gas supply passage 74 extends inside the respective circular disks 36 between the first bridges 34 in the stacking direction indicated by the arrow A.

A ring-shaped insulating seal 76 stacked with a ring 67 is provided between the separators 28. For example, the insulating seal 76 is made of mica material, or ceramic material. An exhaust gas channel 78 of the fuel cells 10 is formed outside the circular disks 36.

As shown in FIG. 1, the fuel cell stack 12 includes end plates 80a, 80b provided at opposite ends of the fuel cells 10 in the stacking direction. The end plates 80a, 80b have a substantially circular disk shape. The end plate 80a has a hole 82 at a central position corresponding to the fuel gas supply passage 30, and a plurality of holes 84 corresponding to the oxygen-containing gas supply passage 74. Components between the end plates 80a, 80b are tightened together in the direction indicated by the arrow A by bolts (not shown) screwed into screw holes 86. Four holes 82 may be provided at positions corresponding to the fuel gas supply passages 30, respectively.

Next, operation of the fuel cell stack 12 will be described below.

As shown in FIG. 2, in assembling the fuel cell stack 12, firstly, the channel member 60 is joined to the surface of the separator 28 facing the cathode 22. Therefore, the internal chamber 69 and the fuel gas supply channel 44 are formed between the separator 28 and the channel member 60. The internal chamber 69 is connected to the fuel gas storage chamber 68 through the fuel gas intake port 66. The fuel gas storage chamber 68 is connected to the four fuel gas supply passages 30 (FIGS. 5 and 6).

The fuel gas supply channel 44 is connected to the fuel gas channel 40 from the fuel gas inlet 38. Since the protrusions 65 of the channel member 60 are joined to the first small diameter end portion 32, the internal chamber 69 and the fuel gas supply passages 30 are sealed from each other between the separator 28 and the channel member 60.

Further, an insulating seal 76 is stacked on the ring 67 between the separators 28. Thus, the fuel gas supply unit 71 in each of the separators 28 extends in the stacking direction to form the chamber 71a.

Eight electrolyte electrode assemblies 26 are sandwiched between the separators 28 to form the fuel cell 10. As shown in FIGS. 2 and 5, the electrolyte electrode assemblies 26 are interposed between the surface 36a of one separator 28 and the surface 36b of the other separator 28. The fuel gas inlet 38 is positioned at substantially the center in each of the anodes 24.

The mesh member 72 is provided between the surface 36b of the separator 28 and the electrolyte electrode assembly 26. The cutout 72a of the mesh member 72 is provided at the position of the channel member 60. A plurality of the fuel cells 10 are stacked in the direction indicated by the arrow A, and the end plates 80a, 80b are provided at opposite ends in the stacking direction to form the fuel cell stack 12.

As shown in FIG. 1, in the fuel cell stack 12, the fuel gas (hydrogen-containing gas) is supplied from the hole 82 of the end plate 80a into each fuel gas supply passage 30, and the oxygen-containing gas (hereinafter also referred to as the air) is supplied from the holes 84 of the end plate 80a to the oxygen-containing gas supply passage 74.

As shown in FIG. 5, the fuel gas flows in the stacking direction indicated by the arrow A along the fuel gas supply passage 30 of the fuel cell stack 12, and flows into fuel gas storage chamber 68 forming the fuel gas supply unit 71 provided in each separator 28. Thus, the fuel gas flowing in the stacking direction is branched to flow along the separator surface in the direction indicated by the arrow B. Then, the fuel gas flows through the fuel gas intake port 66 to the internal chamber 69. The fuel gas further passes along the separator surface through each fuel gas supply channel 44 integrally connected to the internal chamber 69.

The fuel gas is supplied from each fuel gas supply channel 44 to the fuel gas inlet 38 formed in the circular disk 36 into the fuel gas channel 40. Each fuel gas inlet 38 is formed at positions corresponding to substantially the central position of the anode 24 of the electrolyte electrode assembly 26. Thus, the fuel gas is supplied from the fuel gas inlet 38 to substantially the central region of the anode 24, and flows outwardly from the central region of the anode 24 along the fuel gas channel 40.

The air supplied to the oxygen-containing gas supply passage 74 flows into the space between the inner circumferential edge of the electrolyte electrode assembly 26 and the inner circumferential edge of the circular disk 36 in the direction indicated by the arrow B, and flows toward the oxygen-containing gas channel 70 formed by the mesh member 72. In the oxygen-containing gas channel 70, the air flows from the inner circumferential edge (central region of the separator 28) to the outer circumferential edge (outer region of the separator 28), i.e., from one end to the other end of the cathode 22 of the electrolyte electrode assembly 26.

Thus, in the electrolyte electrode assembly 26, the fuel gas flows from the central region to the outer circumferential region of the anode 24, and the air flows in one direction indicted by the arrow B along the electrode surface of the cathode 22. At this time, oxygen ions flow through the electrolyte 20 toward the anode 24 for generating electricity by electrochemical reactions.

The air and the fuel gas used in the electrochemical reaction are discharged to the outside of the respective electrolyte electrode assemblies 26 and then flow through the exhaust gas channel 78 to the outside of the fuel cell stack 12 as an off gas (see FIG. 1).

In the first embodiment, the fuel gas supply unit 71 is formed in each of the separators 28. The fuel gas supply units 71 supply the fuel gas from the fuel gas supply passages 30 to the fuel gas channels 40 arranged in the stacking direction. When the separators 28 are stacked together, the fuel gas supply units 71 provided in the respective separators 28 form the chamber 71a extending in the stacking direction.

Thus, in the chamber 71a, the pressure of the fuel gas is maintained at a certain level. The fuel gas is stored in the fuel gas storage chambers 68 of the fuel gas supply units 71 of the stacked separators 28 at the same pressure. Therefore, the fuel gas flows from the respective fuel gas storage chambers 68 through the fuel gas intake ports 66 into the internal chambers 69, and the fuel gas is supplied from the fuel gas supply channels 44 connected to the internal chambers 69 to the respective fuel gas channels 40. Thus, the uniform power generation in the stacking direction is achieved.

Accordingly, with the simple and economical structure, the fuel gas is uniformly and suitably supplied to the surfaces of the electrolyte electrode assemblies 26 of the stacked fuel cells 10. The desired power generation performance is maintained entirely in the stacking direction.

Further, the fuel gas supply unit 71 includes the fuel gas storage chamber 68 and the fuel gas intake port 66. The pressure loss at the fuel gas intake port 66 is larger than the pressure loss at the fuel gas supply passage 30. Therefore, the fuel gas is distributed equally to the fuel gas supply channels 44 at the same flow rate entirely in the stacking direction.

Further, the opening area of the fuel gas intake port 66 is smaller than the opening area of the fuel gas inlet 38. Therefore, the fuel gas intake port 66 functions as a filter, and it is possible to suitably prevent the fuel gas inlet 38 from being closed by foreign material or the like.

Further, the internal chamber 69 of the fuel gas supply unit 71 is branched into the fuel gas supply channels 44, and a plurality of, e.g., eight electrolyte electrode assemblies 26 are formed along the separator surface for each of the fuel gas supply channels 44. In the structure, the pressure of the fuel gas is regulated such that the fuel gas flows into the fuel gas supply channels 44 at the same pressure, and the fuel gas is supplied equally to the respective electrolyte electrode assemblies 26. Thus, the uniform power generation performance is achieved easily.

Further, since a plurality of the electrolyte electrode assemblies 26 are arranged in the same circle around the fuel gas supply unit 71, the uniform temperature distribution is achieved in the electrolyte electrode assemblies 26, and it is possible to prevent degradation of the power generation performance.

Further, in the first embodiment, the cathode 22 of the electrolyte electrode assembly 26 contacts the mesh member 72. In this state, the load in the stacking direction indicated by the arrow A is applied to the components of the fuel cell 10. Since the mesh member 72 is deformable, the mesh member 72 tightly contacts the cathode 22.

In the structure, the dimensional errors or distortions that occur at the time of production in the electrolyte electrode assembly 26 or the separator 28 can suitably be absorbed by elastic deformation of the mesh member 72. Thus, damage at the time of stacking the components of the fuel cell 10 is prevented. Since the components of the fuel cell 10 contact each other at many points, improvement in the performance of collecting electricity from the fuel cell 10 is achieved.

Further, in the first embodiment, the load in the stacking direction is efficiently transmitted through the projections 42 of the circular disk 36. Therefore, the fuel cells 10 can be stacked together with a small load, and distortion in the electrolyte electrode assemblies 26 and the separators 28 is reduced.

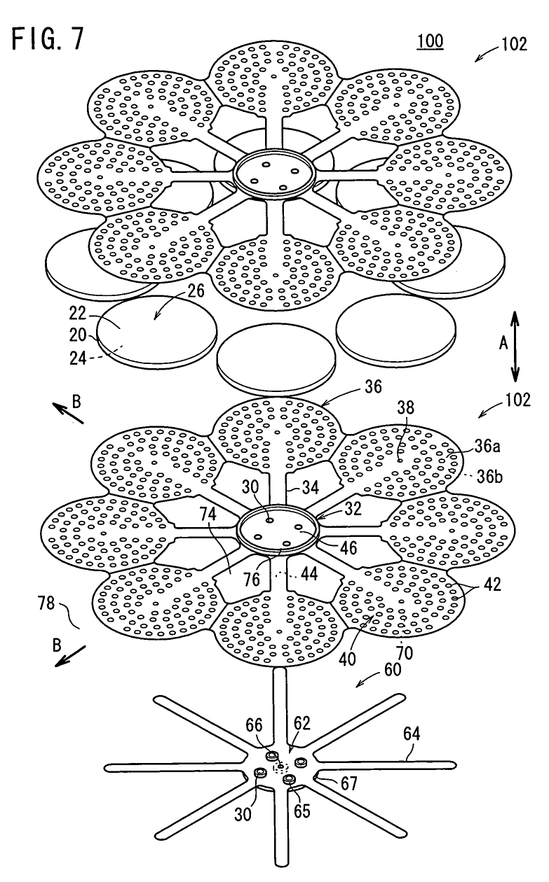

FIG. 7 is an exploded perspective view showing a fuel cell 100 according to a second embodiment of the present invention. The constituent elements that are identical to those of the fuel cell 10 according to the first embodiment are labeled with the same reference numeral, and description thereof will be omitted. Also in third to sixth embodiments as described later, the constituent elements that are identical to those of the fuel cell 10 according to the first embodiment are labeled with the same reference numeral, and description thereof will be omitted.

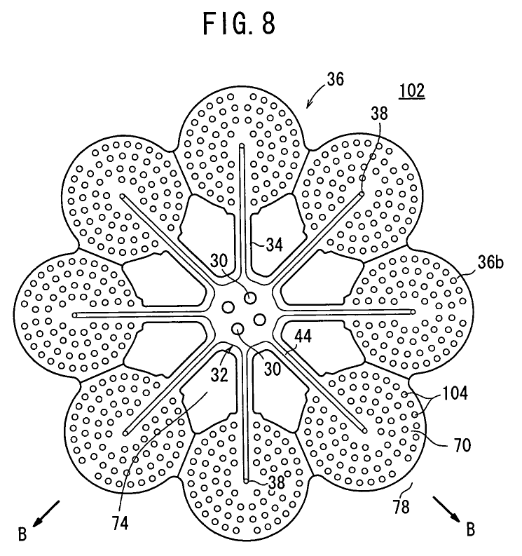

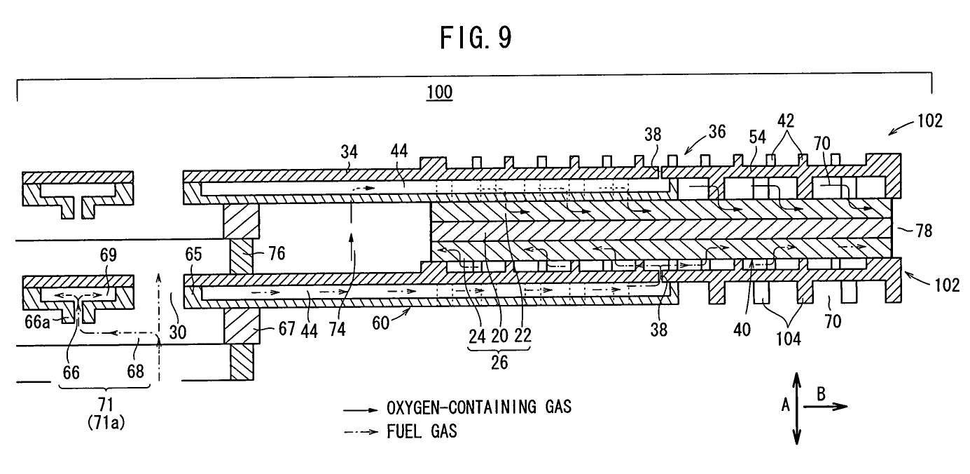

The fuel cell 100 includes a separator 102 having an oxygen-containing gas channel 70 on a surface facing the cathode 22. The oxygen-containing gas channel 70 comprises a plurality of protrusions 104 formed on a surface 36b of each circular disk 36 (see FIGS. 8 and 9). The protrusions 104 have the same structure as that of the projections 42.

In the second embodiment, the same advantages as in the case of the first embodiment can be obtained. For example, it is possible to equally, and suitably supply the fuel gas to the electrolyte electrode assemblies 26 of the fuel cells 100 stacked in the stacking direction.

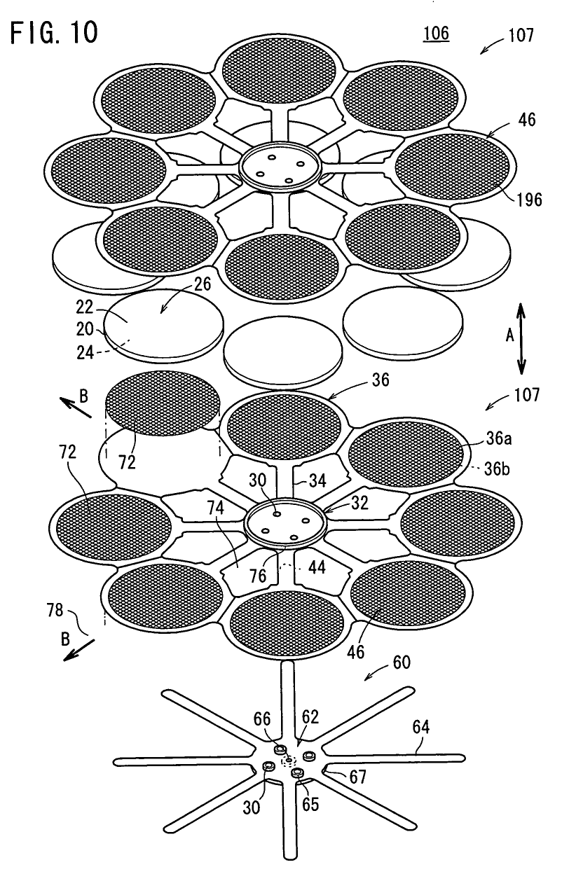

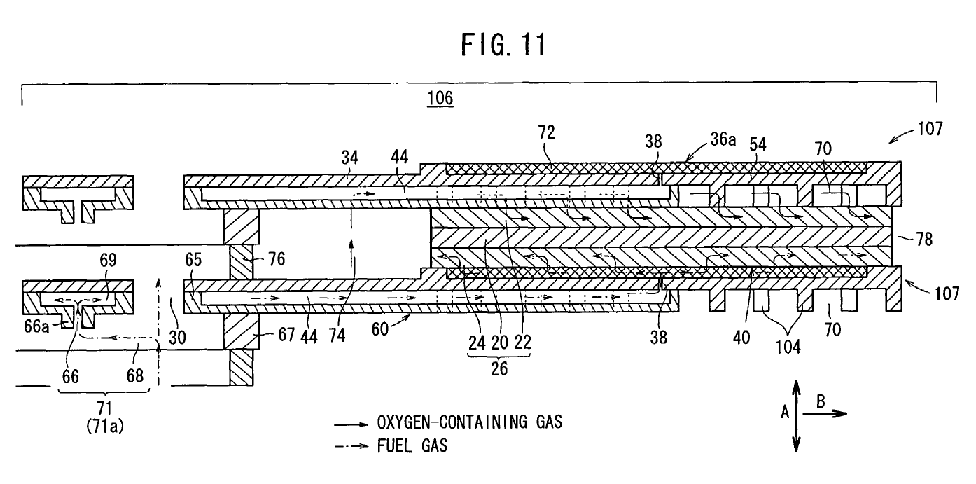

FIG. 10 is an exploded perspective view showing a fuel cell 106 according to a third embodiment of the present invention. FIG. 11 is a cross sectional view showing operation of the fuel cell 106.

The fuel cell 106 includes a separator 107, and a deformable elastic channel member such as an electrically conductive mesh member 72 is provided on a surface 36a of the circular disk 36 of the separator 107. The electrically conductive mesh member 72 forms a fuel gas channel 40 for supplying the fuel gas along a surface of the anode 24, and tightly contacts the anode 24 (see FIGS. 10 and 11).

In the third embodiment, by deformation of the mesh member 72, tight contact between the mesh member 72 and the anode 24 is enhanced.

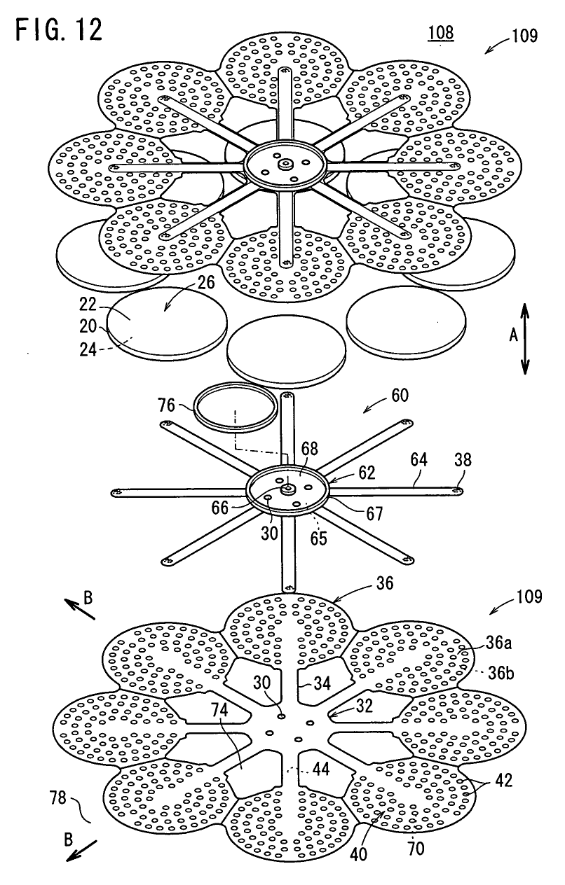

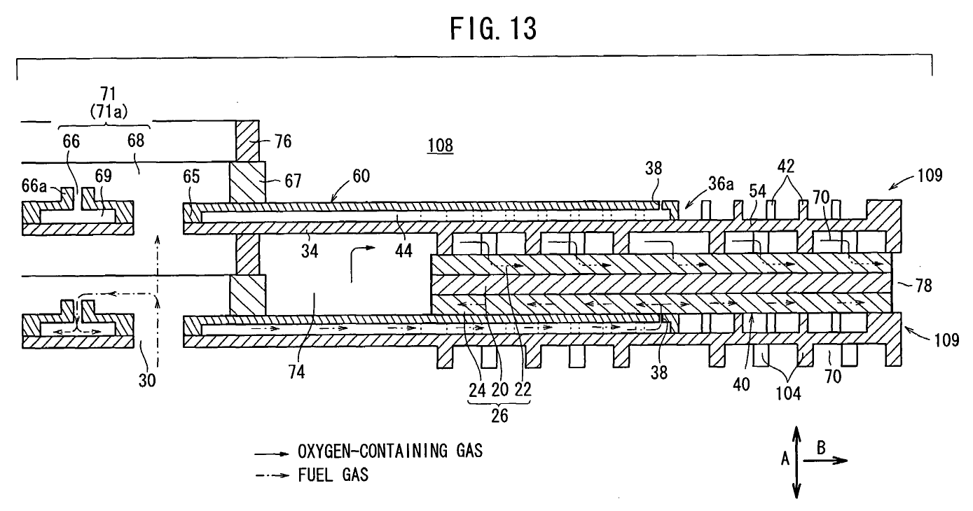

FIG. 12 is an exploded perspective view showing a fuel cell 108 according to a fourth embodiment of the present invention. FIG. 13 is a cross sectional view showing operation of the fuel cell 108.

The fuel cell 108 includes a separator 109, and the channel member 60 is fixed to a surface of the separator 109 facing the anode 24. One or a plurality of fuel gas inlets 38 are formed at each of the front ends of the second bridges 64 of the channel member 60. On the other hand, no fuel gas inlets are provided in the circular disk 36.

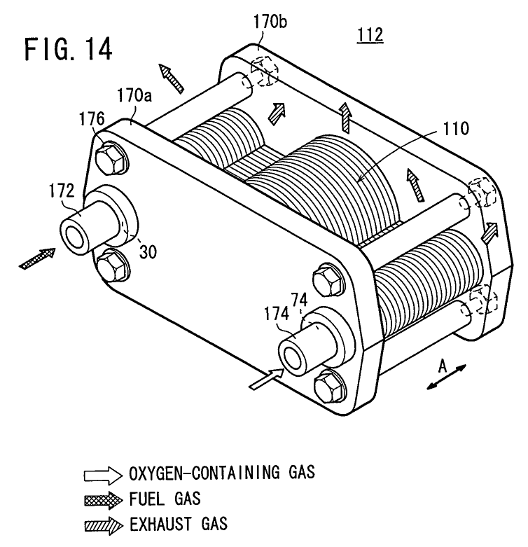

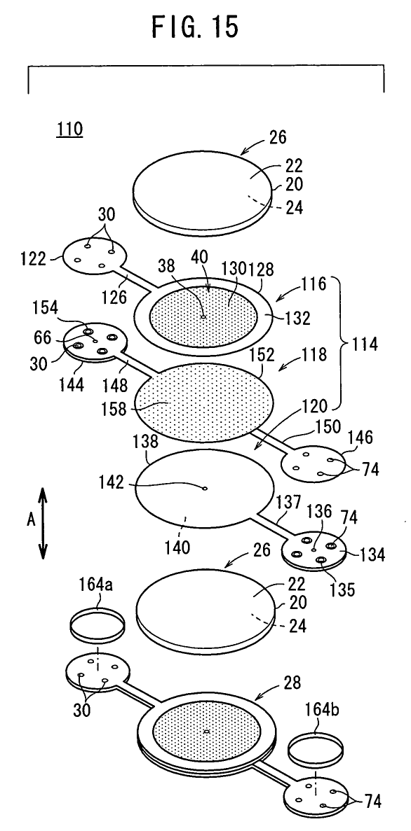

FIG. 14 is a perspective view schematically showing a fuel cell stack 112 formed by stacking a plurality of fuel cells 110 according to a fifth embodiment of the present invention in a direction indicated by an arrow A. FIG. 15 is an exploded perspective view showing the fuel cell 110.

The fuel cell 110 is formed by sandwiching the electrolyte electrode assembly 26 between a pair of separators 114. Each of the separators 114 includes a first plate 116, a second plate 118, and a third plate 120. For example, the first to third plates 116, 118, 120 are metal plates of, e.g., stainless alloy. The first plate 116 and the third plate 120 are joined to both surfaces of the second plate 118 by brazing, for example.

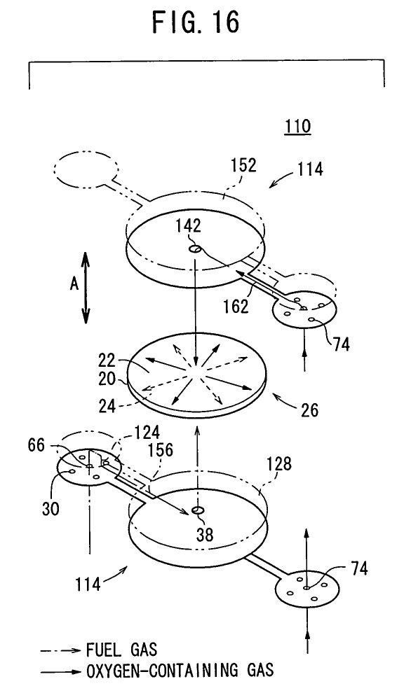

As shown in FIGS. 15 and 16, the first plate 116 has a first small diameter end portion 122. Four fuel gas supply passages 30 for supplying a fuel gas in the stacking direction indicated by the arrow A extend through the first small diameter end portion 122. The first small diameter end portion 122 is integral with a first circular disk 128 having a relatively large diameter through a narrow bridge 126. The first circular disk 128 and the anode 24 of the electrolyte electrode assembly 26 have substantially the same size.

A large number of first protrusions 130 are formed on a surface of the first circular disk 128 which contacts the anode 24, in a central region adjacent to an outer circumferential region. A substantially ring shaped protrusion 132 is provided on the outer circumferential region of the first circular disk 128. The first protrusions 130 and the substantially ring shaped protrusion 132 jointly function as a current collector.

A fuel gas inlet 38 is provided at the center of the first circular disk 128 for supplying the fuel gas toward substantially the central region of the anode 24. The first protrusions 130 may be formed by making a plurality of recesses in a surface which is in the same plane with the surface of the substantially ring shaped protrusion 132.

The third plate 120 has a second small diameter end portion 134. Four oxygen-containing gas supply passages 74 for supplying an oxygen-containing gas in the direction indicated by the arrow A extend through the second small diameter end portion 134. Ring-shaped protrusions 135 formed on the second small diameter end portion 134 surround the four oxygen-containing gas supply passages 74, respectively. An oxygen-containing gas intake port 136 is provided at the center of the second small diameter end portion 134. The second small diameter end portion 134 is integral with a second circular disk 138 having a relatively large diameter through a narrow bridge 137.

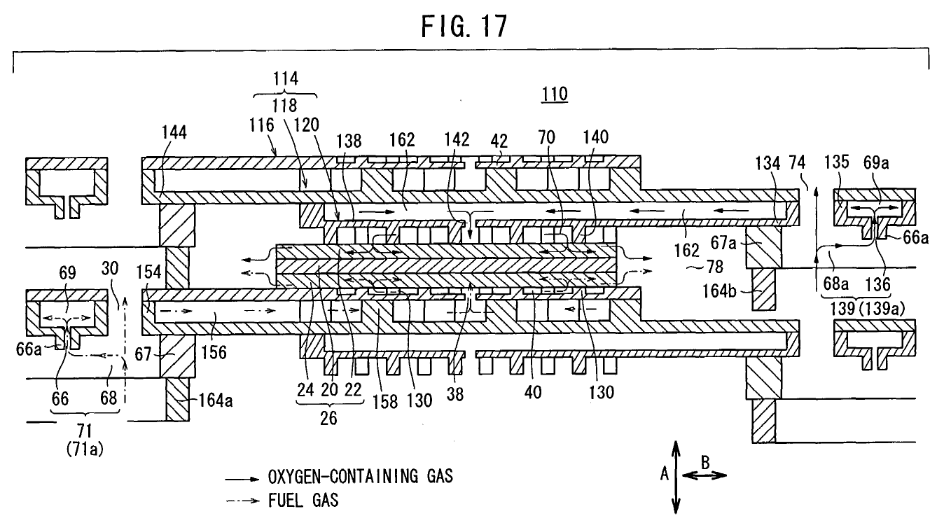

As shown in FIG. 17, a ring 67a is provided separately from, or integrally with the second small diameter end portion 134. An oxygen-containing gas storage chamber 68a is formed inside the ring 67a. The oxygen-containing gas storage chamber 68a is connected to the oxygen-containing gas supply passage 74 and the oxygen-containing gas intake port 136. The oxygen-containing gas intake port 136 is connected to the internal chamber 69a. The internal chamber 69a is sealed from the oxygen-containing gas supply passages 74 by the protrusions 135, and connected to the oxygen-containing gas supply channel 162. The oxygen-containing gas storage chamber 68a, the oxygen-containing gas intake port 136, and the internal chamber 69a forms an oxygen-containing gas supply unit 139.

A plurality of second protrusions 140 as part of the oxygen-containing gas channel 70 are formed in the entire surface of the second circular disk 138 which contacts the cathode 22 of the electrolyte electrode assembly 26 (see FIG. 17). The second protrusions 140 form a current collector. An oxygen-containing gas inlet 142 is provided at the center of the second circular disk 138 for supplying the oxygen-containing gas toward substantially the central region of the cathode 22. The opening area of the oxygen-containing gas intake port 136 is smaller than the total opening area of the four oxygen-containing gas supply passages 74, and the pressure loss in the oxygen-containing gas intake port 136 is larger than the pressure loss in the oxygen-containing gas inlet 142.

The oxygen-containing gas is supplied from the oxygen-containing gas intake port 136 to a plurality of, e.g., eight electrolyte electrode assemblies 26. Therefore, the flow rate of the oxygen-containing gas at the oxygen-containing gas intake port 136 is at least eight times as large as the flow rate of the oxygen-containing gas at the oxygen-containing gas inlet 142. Thus, even if the opening area of the oxygen-containing gas intake port 136 is larger than that of the oxygen-containing gas inlet 142, due to the flow rate difference of the oxygen-containing gas, the pressure loss at the oxygen-containing gas intake port 136 becomes substantially large.

As shown in FIG. 15, the second plate 118 includes a third small diameter end portion 144 and a fourth small diameter end portion 146. Four fuel gas supply passages 30 and the fuel gas intake port 66 extend through the third small diameter end portion 144, and four oxygen-containing gas supply passages 74 extend through the fourth small diameter end portion 146. The third and fourth small diameter end portions 144, 146 are integral with a third circular disk 152 having a relatively large diameter through narrow bridges 148, 150, respectively. The first to third circular disks 128, 138, 152 have the same diameter.

A ring shaped protrusion 154 is formed on the third small diameter end portion 144 around each fuel gas supply passage 30. A fuel gas supply channel 156 connected to the fuel gas inlet 38 is provided between the bridges 126, 148 (see FIG. 17). The third circular disk 152 has a plurality of third protrusions 158, and the third protrusions 158 form part of the fuel gas supply channel 156. An oxygen-containing gas supply channel 162 connected to an oxygen-containing gas inlet 142 is formed between bridges 137, 150 (see FIGS. 15 and 17).

The first plate 116 is joined to the second plate 118 by brazing to form the fuel gas supply channel 156 connected to the fuel gas supply channel 40 between the first and second plates 116, 118. Likewise, the second plate 118 is joined to the third plate 120 by brazing to form an oxygen-containing supply channel 162 connected to the oxygen-containing gas channel 70 between the second and third plates 118, 120.

An insulating seal 164a for sealing the fuel gas supply passage 30 and an insulating seal 164b for sealing the oxygen-containing gas supply passage 74 are provided between the separators 28. For example, the insulating seals 164a, 164b are made of mica material, or ceramic material.

As shown in FIG. 14, the fuel cell stack 112 includes end plates 170a, 170b provided at opposite ends of the fuel cells 110 in the stacking direction. A first pipe 172 and a second pipe 174 extend through the end plate 170a. The first pipe 172 is connected to the fuel gas supply passage 30 of the fuel cells 110, and the second pipe 174 is connected to the oxygen-containing gas supply passage 74 of the fuel cells 110. The end plate 170a and the end plate 170b are tightened by tightening bolts 176, while the end plate 170a or the end plate 170b is electrically insulated from the tightening bolts 176.

Next, operation of the fuel cell stack 112 will be described blow.

In the fuel cell stack 112, a fuel gas such as a hydrogen-containing gas is supplied to the first pipe 172 connected to the end plate 170a, and the fuel gas flows from the first pipe 172 to the fuel gas supply passage 30. An oxygen-containing gas (hereinafter referred to as the air) is supplied to the second pipe 174 connected to the end plate 170a, and the air flows from the second pipe 174 to the oxygen-containing gas supply passage 74 (see FIG. 14).

As shown in FIG. 17, the fuel gas supplied to the fuel gas supply passage 30 flows in the stacking direction indicated by the arrow A, and flows separately into the fuel gas storage chambers 68 of the separators 114. Then, the fuel gas flows through the fuel gas intake ports 66, and the fuel gas flows separately from the internal chambers 69 into the fuel gas supply channels 156.

The oxygen-containing gas supplied to the oxygen-containing gas supply passage 74 in the stacking direction flows separately into the oxygen-containing gas storage chambers 68a of the separators 114. The oxygen-containing gas flows through the oxygen-containing gas intake ports 136, and the oxygen-containing gas flows separately from the internal chambers 69a into the oxygen-containing gas supply channels 162. Then, the oxygen-containing gas flows into the oxygen-containing gas channels 70 through the oxygen-containing gas inlets 142 connected to the oxygen-containing gas supply channels 162.

Thus, in each of the electrolyte electrode assemblies 26, the fuel gas is supplied from the central region of the anode 24 to the outer circumferential region of the anode 24, and the oxygen-containing gas is supplied from the central region of the cathode 22 to the outer circumferential region of the cathode 22 for generating electricity. After the fuel gas and the air are consumed in the power generation, the fuel gas and the oxygen-containing gas are discharged as an exhaust gas into the exhaust gas channel 78 from the outer circumferential portions of the first to third circular disks 128, 138, and 152.

In the fifth embodiment, as shown in FIG. 17, when the separators 114 are stacked together, the oxygen-containing gas supply units 139 provided in the respective separators 114 form the chamber 139a extending in the stacking direction. In the chamber 139a, the pressure of the oxygen-containing gas is maintained at a certain level. The oxygen-containing gas is stored in each of the oxygen-containing gas supply units 139 of the stacked separators 114 at the same pressure. Thus, the oxygen-containing gas is supplied from the oxygen-containing gas supply units 139 equally to the oxygen-containing gas channels 70 through the oxygen-containing gas supply channels 162 at the same flow rate, and the uniform power generation reaction in the stacking direction is achieved.

Likewise, also in the fuel gas supply unit 71, a single chamber 71a is formed to extend through the separators 114 stacked in the stacking direction, and the fuel gas is equally supplied to the fuel gas channels 40.

Accordingly, the same advantages as in the cases of the first to fourth embodiments can be obtained. For example, with simple structure, uniform power generation reaction is achieved, and the power generation efficiency is improved.

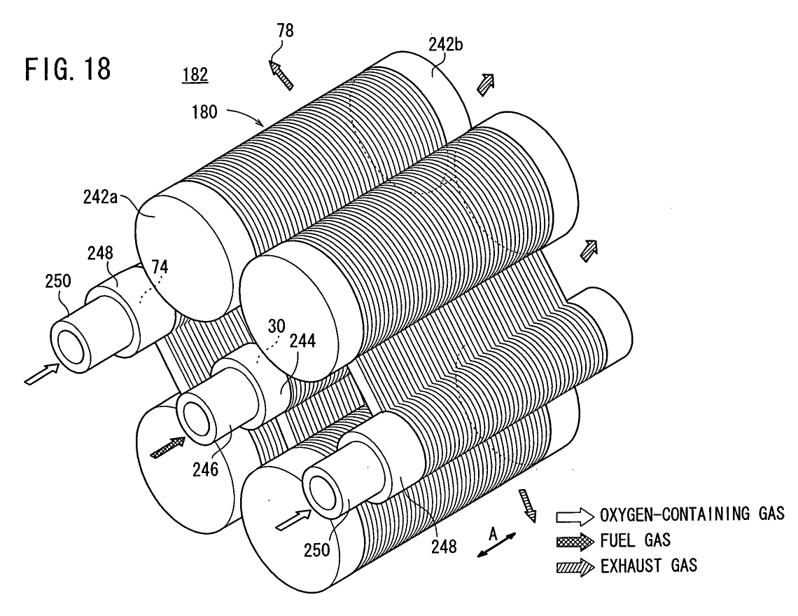

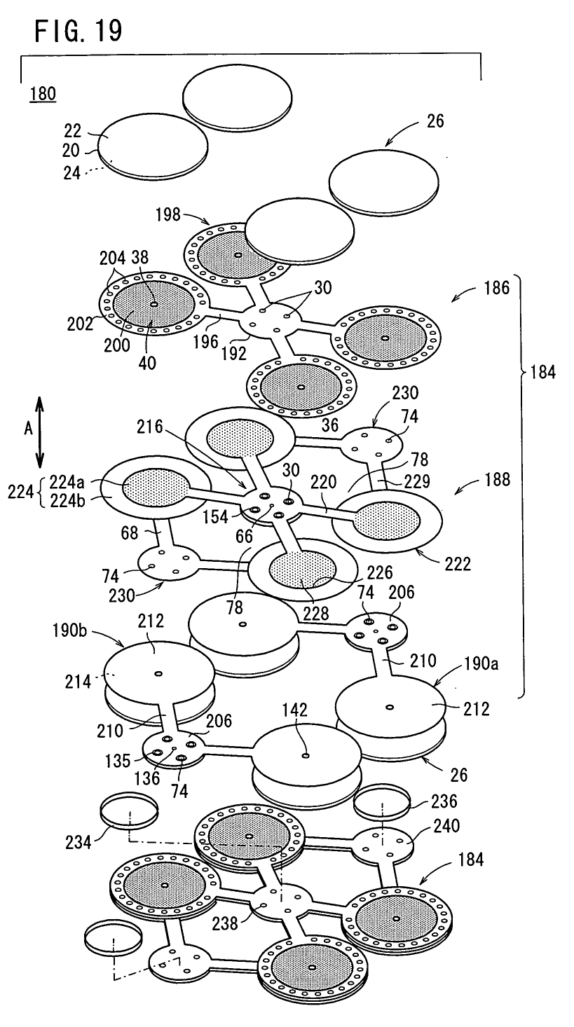

FIG. 18 is a perspective view schematically showing a fuel cell stack 182 formed by stacking fuel cells 180 according to a sixth embodiment in the direction indicated by the arrow A. FIG. 19 is an exploded perspective view showing the fuel cell 180. The constituent elements that are identical to those of the fuel cell 110 according to the fifth embodiment are labeled with the same reference numeral, and description thereof will be omitted.

As shown in FIG. 19, the fuel cell 180 is formed by sandwiching four electrolyte electrode assemblies 26 between a pair of separators 184. The separator 184 includes a first plate 186, a second plate 188, and a pair of third plates 190a, 190b. For example, the first to third plates 186, 188, 190a, 190b are metal plates of, e.g., stainless alloy. The first plate 186 and the third plates 190a, 190b are joined to both surfaces of the second plate 188 by brazing, for example.

The first plate 186 has a first small diameter end portion 192 through which four fuel gas supply passages 30 extend. The first small diameter end portion 192 is integral with four first circular disks 198 each having a relatively large diameter through four narrow bridges 196.

A large number of first protrusions 200 are formed on a surface of the first circular disk 198 which contacts the anode 24, in a central region adjacent to an outer circumferential region. A substantially ring shaped protrusion 202 is provided in the outer circumferential region of the first circular disk 198. The first protrusions 200 and the substantially ring shaped protrusion 202 jointly form a current collector.

A fuel gas inlet 38 is provided at the center of the first circular disk 198 for supplying the fuel gas toward substantially the central region of the anode 24. A plurality of exhaust fuel gas branching ports 204 are provided in the outer circumferential region of the first circular disk 198 so as to penetrate the substantially ring shaped protrusion 202.

Each of the third plates 190a, 190b has a second small diameter end portion 206. The second small diameter end portion 206 has the oxygen-containing gas supply passage 74, the protrusion 135 and oxygen-containing gas intake port 136. The second small diameter end portion 206 is integral with two second circular disks 212 each having a relatively large diameter through two narrow bridges 210.

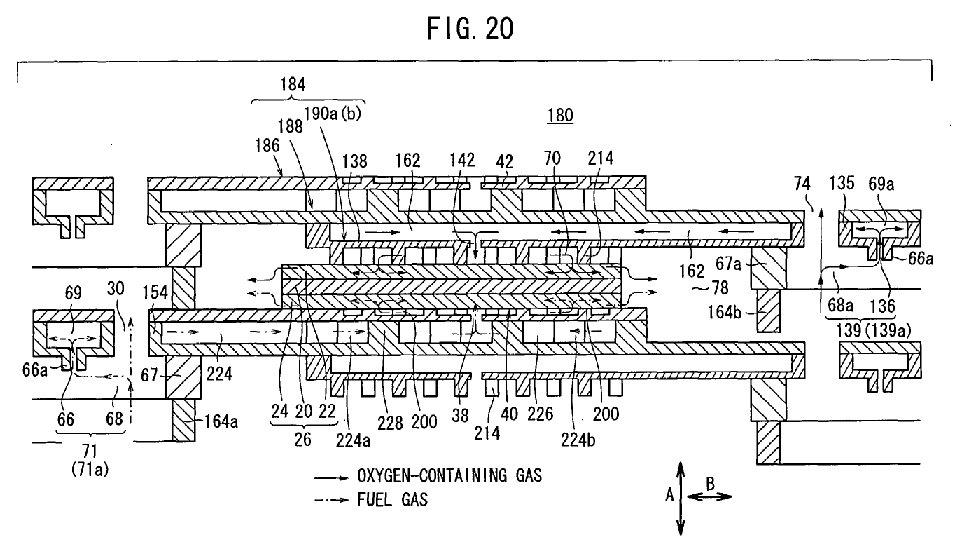

As shown in FIG. 20, a plurality of second protrusions 214 are formed on the entire surface of the second circular disk 212 which contacts the cathode 22 of the electrolyte electrode assembly 26. The second protrusions 214 form a current collector. An oxygen-containing gas inlet 142 is provided at the center of the second circular disk 212 for supplying the oxygen-containing gas toward substantially the central region of the cathode 22.

The second plate 188 includes a third small diameter end portion 216. The third small diameter end portion 216 has the fuel gas supply passage 30, the protrusion 154 and the fuel gas intake port 66. The third small diameter end portion 216 is integral with four third circular disks 222 each having a relatively large diameter through four narrow bridges 220.

The third circular disks 222 have fuel gas supply channels 224, respectively. Each of the fuel gas supply channels 224 is divided into first and second fuel gas channel units 224a, 224b through a partition 226 formed by a substantially ring shaped ridge. A plurality of third protrusions 228 are provided inside the partition 226.

The four third circular disks 222 are integral with two fourth small diameter end portions 230. The fourth small diameter end portion 230 has four oxygen-containing gas supply passage 74. Insulating seals 234, 236 are provided around the fuel gas supply passage 30 and the oxygen-containing gas supply passage 74 between the separators 184.

As shown in FIG. 18, in the fuel cell stack 182, four end plates 242a, 242b are provided at each of opposite ends of the fuel cells 180. A plate 244 is provided at each of opposite ends of the fuel gas supply passage 30 in the direction indicated by the arrow A, and a first pipe 246 for supplying the fuel gas to the fuel gas supply passage 30 is connected to the plate 244.

Two plates 248 are provided at each of the opposite ends of the oxygen-containing gas supply passages 74 in the direction indicated by the arrow A. The plates 248 are connected to the second pipes 250 for supplying the air to the oxygen-containing gas supply passages 74. The plates 244 and the plates 248 at opposite ends in the stacking direction indicated by the arrow A are fixed by tightening bolts 252.

In the sixth embodiment, as shown in FIG. 18, the fuel gas is supplied to the fuel gas supply passage 30 in the fuel cell stack 182 through the first pipe 246, and the air is supplied to the oxygen-containing gas supply passages 74 in the fuel cell stack 182 through the second pipes 250.

As shown in FIG. 20, the fuel gas supplied to the fuel gas supply passage 30 flows in the stacking direction, and branched into the fuel gas supply unit 71 of the separators 184 of each of the fuel cells 180. Then, the fuel gas is supplied to the respective fuel gas supply channels 224 through the fuel gas intake port 66. The fuel gas flows into the first fuel gas supply channel units 224a through the fuel gas supply channels 224.

Thus, the fuel gas supplied to the first fuel gas supply channel units 224a flows toward the central positions of the anodes 24 of the electrolyte electrode assemblies 26 through the fuel gas inlets 38.

The air supplied to the oxygen-containing gas supply passage 74 is branched into the oxygen-containing gas supply unit 139 of the separators 184, and flows through the oxygen-containing gas supply channels 162 through the oxygen-containing gas intake port 136. Then, the air flows toward the central positions of the cathodes 22 of the electrolyte electrode assemblies 26 through the oxygen-containing gas inlets 142 provided at the center of the second circular disk 212.

In the sixth embodiment, the same advantages as in the cases of the first to fifth embodiments can be obtained.

While the invention has been particularly shown and described with reference to preferred embodiments, it will be understood that variations and modifications can be effected thereto by those skilled in the art without departing from the spirit and scope of the invention as defined by the appended claims.

What is claimed is:

1. A fuel cell stack formed by stacking a plurality of fuel cells, each of which is formed by stacking an electrolyte electrode assembly and a separator, said electrolyte electrode assembly including an anode, a cathode, and an electrolyte interposed between said anode and said cathode, said fuel cell comprising:
a fuel gas channel provided on one surface of said separator for supplying a fuel gas along a surface of said anode;
an oxygen-containing gas channel provided on the other surface of said separator for supplying an oxygen-containing gas along a surface of said cathode;
a fuel gas supply passage extending in a stacking direction of said separator for allowing the fuel gas to flow in the stacking direction;
a fuel gas supply unit provided in said separator for dividing the flow of the fuel gas, and supplying the fuel gas from said fuel gas supply passage to said fuel gas channel of said separator,
wherein said fuel gas supply unit forms a chamber extending through said separators in the stacking direction when said fuel cells are stacked together.

2. A fuel cell stack according to claim 1, wherein said fuel gas supply unit comprises:
a fuel gas storage chamber connected to said fuel gas supply passage;
a fuel gas intake port connected to said fuel gas storage chamber for taking the fuel gas from said fuel gas storage chamber; and
a fuel gas supply channel for supplying the fuel gas taken from said fuel gas intake port to said fuel gas channel,
wherein said separator has a fuel gas inlet connecting said fuel gas supply channel and said fuel gas channel for supplying the fuel gas to said anode; and
the pressure loss at said fuel gas intake port is larger than the pressure loss at said fuel gas supply passage.

3. A fuel cell stack according to claim 2, wherein the total opening area of said fuel gas intake port is smaller than the total opening area of said fuel gas supply passage.

4. A fuel cell stack according to claim 2, the pressure loss at said fuel gas intake port is larger than the pressure loss at said fuel gas inlet.

5. A fuel cell stack according to claim 4, wherein the flow rate of the fuel gas at said fuel gas intake port is larger than the flow rate of the fuel gas at said fuel gas inlet.

6. A fuel cell stack according to claim 2, wherein said fuel gas supply unit is branched into a plurality of said fuel gas supply channels; and
a plurality of said electrolyte electrode assemblies are provided along a surface of said separator for each of said fuel gas supply channels.

7. A fuel cell stack according to claim 6, wherein said fuel gas supply unit is provided at the center of said separator; and
a plurality of said electrolyte electrode assemblies are arranged on one virtual circle around said fuel gas supply unit.

8. A fuel cell stack according to claim 7, wherein said fuel gas supply unit has an internal chamber connected to said fuel gas storage chamber through said fuel gas intake port; and
said internal chamber is connected to a plurality of said fuel gas supply channels.

9. A fuel cell stack according to claim 2, wherein said separator comprises a single plate;
said fuel gas channel is provided between one surface of said plate and said anode;
said oxygen-containing gas channel is provided between the other surface of said plate and said cathode; and
a fuel gas channel member forming said fuel gas supply channel is provided on the one surface or on the other surface of said plate.

10. A fuel cell stack formed by stacking a plurality of fuel cells, each of which is formed by stacking an electrolyte electrode assembly and a separator, said electrolyte electrode assembly including an anode, a cathode, and an electrolyte interposed between said anode and said cathode, said fuel cell comprising:
a fuel gas channel provided on one surface of said separator for supplying a fuel gas along a surface of said anode;
an oxygen-containing gas channel provided on the other surface of said separator for supplying an oxygen-containing gas along a surface of said cathode;
an oxygen-containing gas supply passage extending through said separator in a stacking direction for allowing the oxygen-containing gas to flow in the stacking direction; and
an oxygen-containing gas supply unit provided in said separator for dividing the flow of the oxygen-containing gas from said oxygen-containing gas supply passage, and supplying the oxygen-containing gas to said oxygen-containing gas channel,
wherein said oxygen-containing gas supply unit forms a chamber extending in the stacking direction when said fuel cells are stacked together.

11. A fuel cell stack formed by stacking a plurality of fuel cells, each of which is formed by stacking an electrolyte electrode assembly and a separator, said electrolyte electrode assembly including an anode, a cathode, and an electrolyte interposed between said anode and said cathode, said fuel cell comprising:
a fuel gas channel provided on one surface of said separator for supplying a fuel gas along a surface of said anode;
an oxygen-containing gas channel provided on the other surface of said separator for supplying an oxygen-containing gas along a surface of said cathode;
a fuel gas supply passage extending through said separator in a stacking direction for allowing the fuel gas to flow in the stacking direction;
an oxygen-containing gas supply passage extending though said separator in the stacking direction for allowing the oxygen-containing gas to flow in the stacking direction;
a fuel gas supply unit provided in said separator for dividing the flow of the fuel gas from said fuel gas supply passage and supplying the fuel gas to said fuel gas channel;
an oxygen-containing gas supply unit provided in said separator for dividing the flow of the oxygen-containing gas from said oxygen-containing gas supply passage, and supplying the oxygen-containing gas to said oxygen-containing gas channel; and
said fuel gas supply unit and said oxygen-containing gas supply unit form chambers, respectively extending in the stacking direction when said fuel cells are stacked together.

12. A fuel cell stack according to claim 11, wherein said fuel gas supply unit comprises a fuel gas storage chamber connected to said fuel gas supply passage;
a fuel gas intake port connected to said fuel gas storage chamber for taking the fuel gas from said fuel gas storage chamber;
a fuel gas supply channel for supplying the fuel gas taken from said fuel gas intake port to said fuel gas channel,
wherein said oxygen-containing gas supply unit comprises an oxygen-containing gas storage chamber connected to said oxygen-containing gas supply passage;
an oxygen-containing gas intake port connected to said oxygen-containing gas storage chamber for taking the oxygen-containing gas from said oxygen-containing gas storage chamber; and
an oxygen-containing gas supply channel for supplying the oxygen-containing gas taken from said oxygen-containing gas intake port to said oxygen-containing gas channel.

13. A fuel cell stack according to claim 12, wherein said separator has a fuel gas inlet connecting said fuel gas supply channel and said fuel gas channel for supplying the fuel gas to said anode; and
the pressure loss at said fuel gas intake port is larger than the pressure loss at said fuel gas supply passage.

14. A fuel cell stack according to claim 12, wherein said separator has an oxygen-containing gas inlet connecting said oxygen-containing gas supply channel and said oxygen-containing gas channel for supplying the oxygen-containing gas to said cathode; and
the pressure loss at said oxygen-containing gas intake port is larger than the pressure loss at said oxygen-containing gas supply passage.

15. A fuel cell stack according to claim 12 wherein said separator comprises first to third plates which are stacked together;
said fuel gas channel is formed between said first plate and said anode, and said oxygen-containing gas channel is formed between said third plate and said cathode; and
said fuel gas supply channel is formed between said first plate and said second plate and said oxygen-containing gas supply channel is formed between said third plate and said second plate.
